(19) United States
(12) Patent Application Publication
(10) Pub. No.: US 2013/0313490 A1
(43) Pub. Date: Nov. 28, 2013

(54) METAL SOL CONTAINING DOPED SILVER NANOPARTICLES

(71) Applicants: Stefanie Eiden, Leverkusen (DE); Elsa Karoline Schaedlich, Bonn (DE)

(72) Inventors: Stefanie Eiden, Leverkusen (DE); Elsa Karoline Schaedlich, Bonn (DE)

(73) Assignee: BAYER TECHNOLOGY SERVICES GMBH, Leverkusen (DE)

(21) Appl. No.: 13/881,256

(22) PCT Filed: Oct. 20, 2011
(86) PCT No.: PCT/EP2011/068344

§ 371 Date: Aug. 12, 2013

(30) Foreign Application Priority Data
Oct. 25, 2010 (EP) 10188779.2

(51) Int. Cl. H01B 1/22

(52) U.S. Cl. CPC H01B 1/22
USPC 252/514

(57) ABSTRACT

The invention relates to a metal particle sol, which comprises silver nanoparticles that are doped with a metal or a metal compound selected from the group of metals: ruthenium, rhodium, palladium, osmium, iridium and platinum, preferably ruthenium, to a method for producing such a sol and to its use.

The invention relates to a metal particle sol, which comprises silver nanoparticles that are doped with a metal or a metal compound selected from the group of metals: ruthenium, rhodium, palladium, osmium, iridium and platinum, preferably ruthenium, to a method for producing such a sol and to its use.

Metal particle sols containing silver nanoparticles are used inter alia for the production of conductive coatings or for the production of inks for inkjet and screenprinting methods for the purpose of producing conductive structured coatings, for example in the form of microstructures, by means of printing methods. In this context, for example, the coating of flexible plastic substrates is of great importance, for example for the production of flexible RFID tags. In order to achieve sufficient conductivity, the coatings applied by means of the silver nanoparticle sols must be dried and sintered for a sufficient time at elevated temperatures, which represents a considerable thermal stress for the plastic substrates.

Attempts are therefore being made to reduce the sintering times and/or the sintering temperatures, which are necessary in order to achieve sufficient conductivities, by suitable measures so that such thermal stress on the plastic substrates can be decreased.

WO 2007/118669 A1 describes the production of metal particle sols, wherein the metal salt solution used for production comprises ions which are selected from the group consisting of iron, ruthenium, osmium, cobalt, rhodium, iridium, nickel, palladium, platinum, copper, silver, gold, zinc and/or cadmium. WO 2007/118669 A1 does not, however, describe any measures for reducing the sintering time or sintering temperature.

U.S. Pat. No. 4,778,549 describes that the decomposition of organic materials from glass or ceramic bodies when heating to temperatures of more than 750° C. can be accelerated by the presence of catalytically acting metals selected from the group: ruthenium, rhodium, palladium, osmium, iridium and platinum. It is known from J. Am. Chem. Soc. 1989, 111, 1185-1193 that the decomposition of polymeric ethers can be catalyzed on the metallic surface of Ru(001). However, neither of these documents gives an indication of how the sintering times and/or sintering temperatures of silver nanoparticle coatings, which are necessary for achieving sufficient conductivities, can be reduced in order to decrease the thermal stress on plastic substrates.

There was therefore still a need for a simple way of reducing the sintering times and/or sintering temperatures of coatings containing silver nanoparticles, in order to decrease the thermal stress on plastic substrates, while at the same time achieving a conductivity which is sufficient for the application.

It was therefore an object of the present invention to find a metal particle sol containing silver nanoparticles, and a method for its production, with which the sintering times and/or sintering temperatures necessary for achieving sufficient conductivities can be reduced so that a thermal stress, in particular on plastic substrates, can be decreased.

Surprisingly, it has been found that doping the silver nanoparticles with a content of from 0.1 to 10 wt % of a metal selected from the group: ruthenium, rhodium, palladium, osmium, iridium and platinum, expressed in terms of the silver content of the metal particle sol, in the form of the metal or at least one compound of such a metal significantly reduces the sintering time which is necessary in order to achieve a sufficient conductivity. The sintering times can be reduced by up to 80% in this case, which leads to considerable thermal stress relief in particular for thermally sensitive plastic substrates, and at the same time can widen the available range of possible plastic substrates to be coated with such conductive structures. As an alternative, using comparable sintering times, significantly higher conductivities can be achieved with the metal particle sols according to the invention than with known silver nanoparticle sols without the corresponding doping.

The present invention accordingly provides a metal nanoparticle sol having a metal nanoparticle content ≧1 g/l, containing
silver nanoparticles
at least one dispersant and
at least one liquid dispersion medium

characterized in that the metal particle sol contains from 0.1 to 10 wt % of at least one metal selected from the group: ruthenium, rhodium, palladium, osmium, iridium and platinum, expressed in terms of the silver content of the metal nanoparticle sol, in the form of the metal and/or at least one metal compound.

Preferably, the content of the metal selected from the group: ruthenium, rhodium, palladium, osmium, iridium and platinum, in the form of the metal and/or at least one metal compound, is an amount of from 0.1 to 5 wt %, particularly preferably an amount of from 0.4 to 2 wt %, expressed in terms of the silver content of the metal nanoparticle sol.

In the scope of the invention, the metal selected from the group: ruthenium, rhodium, palladium, osmium, iridium and platinum is preferably ruthenium. In the metal nanoparticle sols according to the invention, preferably at least 90 wt %, more preferably at least 95 wt %, particularly preferably at least 99 wt %, more particularly preferably all of the ruthenium is present in the form of ruthenium dioxide.

In the most preferred embodiments, the silver nanoparticles in the metal nanoparticle sol comprise at least 80%, preferably at least 90% of the content of the at least one metal selected from the group: ruthenium, rhodium, palladium, osmium, iridium and platinum. The metal nanoparticle sol contains only a small amount of silver-free metal nanoparticles or metal compound nanoparticles of this metal selected from the group: ruthenium, rhodium, palladium, osmium, iridium and platinum. Preferably, the metal nanoparticle sol contains less than 20%, particularly preferably less than 10%—expressed in terms of the content of this metal—of the content of this metal selected from the group: ruthenium, rhodium, palladium, osmium, iridium and platinum in the form of silver-free metal nanoparticles or metal compound nanoparticles of this metal.

In general, the metal nanoparticle sol according to the invention preferably has a metal nanoparticle content of from 1 g/l to 25.0 g/l. By using concentration steps, however, metal nanoparticle contents of up to 500.0 g/l or more may also be achieved.

In the scope of the invention, metal nanoparticles are intended to mean ones having an effective hydrodynamic diameter of less than 300 nm, preferably having an effective hydrodynamic diameter of from 0.1 to 200 nm, particularly preferably from 1 to 150 nm, more particularly preferably from 20 to 140 nm, measured by means of dynamic light scattering. For example, a ZetaPlus Zeta Potential Analyzer from Brookhaven Instrument Corporation is suitable for the measurement by means of dynamic light scattering.

The metal nanoparticles are dispersed with the aid of at least one dispersant in at least one liquid dispersion medium.

Accordingly, the metal nanoparticle sols according to the invention are distinguished by a high colloidal chemical stability, which is preserved even if concentration is carried out. The term “colloidally chemically stable” in this case means that the properties of the colloidal dispersion or the colloids do not change greatly even over the conventional storage times before application, and for example no substantial aggregation or flocculation of the colloid particles takes place.

Polymeric dispersants are preferably used as dispersants, preferably ones having a molecular weight (weight average) M_{w} of from 100 g/mol to 1 000 000 g/mol, particularly preferably from 1000 g/mol to 100 000 g/mol. Such dispersants are commercially available. The molecular weights (weight average) M_{w} may be determined by means of gel permeation chromatography (GPC), preferably by using polystyrene as a standard.

The choice of the dispersant also makes it possible to adjust the surface properties of the metal nanoparticles. Dispersant adhering to the particle surface may, for example, impart a positive or negative surface charge to the particles.

In a preferred embodiment of the present invention, the dispersant is selected from the group consisting of alkoxylates, alkylolamides, esters, amine oxides, alkyl polyglucosides, alkylphenols, arylalkylphenols, water-soluble homopolymers, statistical copolymers, block copolymers, graft polymers, polyethylene oxides, polyvinyl alcohols, copolymers of polyvinyl alcohols and polyvinyl acetates, polyvinylpyrrolidones, cellulose, starch, gelatin, gelatin derivatives, amino acid polymers, polylysine, polyasparagic acid, polyacrylates, polyethylene sulphonates, polystyrene sulphonates, polymethacrylates, condensation products of aromatic sulphonic acids with formaldehyde, naphthalene sulphonates, lignosulphonates, copolymers of acrylic monomers, polyethyleneimines, polyvinylamines, polyallylamines, poly(2-vinylpyridines) and/or polydiallyldimethylammonium chloride.

Such dispersants may on the one hand affect the particle size or the particle size distribution of the metal nanoparticle sols. For some applications, it is important for there to be a narrow particle size distribution. For other applications, it is advantageous for there to be a wide or multimodal particle size distribution, since the particles can adopt denser packing. Another advantage to be mentioned of the said dispersants is that they can impart expedient properties to the particles on the surfaces of which they adhere. Besides the aforementioned positive and negative surface charges, which can make a contribution to the colloidal stability by mutual repulsion, the hydrophilicity or hydrophobicity of the surface and the biocompatibility may also be mentioned. Hydrophilicity and hydrophobicity of the nanoparticles are important, for example, when the particles are intended to be dispersed in a particular medium, for example in polymers. Biocompatibility of the surfaces makes it possible to use the nanoparticles in medical applications.

The liquid dispersion medium/media is or are preferably water or mixtures containing water and organic solvents, preferably water-soluble organic solvents. Other solvents may however also be envisaged, for example when the method is intended to be carried out at temperatures below 0° C. or above 100° C. or when the product obtained is intended to be incorporated into matrices in which the presence of water would cause problems. For example, polar protic solvents such as alcohols and acetone, polar aprotic solvents such as N,N-dimethylformamide (DMF) or nonpolar solvents such as CH₂Cl₂ may be used. The mixtures preferably contain at least 50 wt %, preferably at least 60 wt % of water, particularly preferably at least 70 wt % of water. The liquid dispersion medium/media is or are particularly preferably water or mixtures of water with alcohols, aldehydes and/or ketones, particularly preferably water or mixtures of water with mono- or polyvalent alcohols having up to four carbon atoms, for example methanol, ethanol, n-propanol, isopropanol or ethylene glycol, aldehydes having up to four carbon atoms, for example formaldehyde, and/or ketones having up to four carbon atoms, for example acetone or methyl ethyl ketone. Water is a more particularly preferred dispersion medium.

The present invention furthermore provides a method for producing the metal nanoparticle sols according to the invention.

A method in which at least partially nanoscale metal oxide and/or metal hydroxide particles are initially produced, and reduced in a subsequent step, in order to produce nanoscale metal particles, has proven particularly advantageous. In the scope of the present invention, however, merely reduction of the silver oxide and/or silver hydroxide and/or silver oxide-hydroxide to elemental silver takes place in this case. The metal oxides of the metals selected from the group: ruthenium, rhodium, palladium, osmium, iridium and platinum are not or not completely, and preferably not, reduced to the elemental metal.

The present invention accordingly provides a method for producing a metal nanoparticle sol according to the invention, characterized in that
a) a silver salt solution, a solution containing at least one metal salt of a metal selected from the group: ruthenium, rhodium, palladium, osmium, iridium and platinum, and a solution containing hydroxide ions are combined,
b) the solution obtained from step a) is subsequently reacted with a reducing agent,

at least one of the solutions in step a) containing at least one dispersant, characterized in that the three solutions are combined simultaneously in step a).

Surprisingly, it has been found that the sintering time necessary to achieve a sufficient conductivity can only be reduced with the metal nanoparticle sols obtained if, in step a), the silver salt solution, the solution containing at least one metal salt of a metal selected from the group: ruthenium, rhodium, palladium, osmium, iridium and platinum, and the solution containing hydroxide ions are combined simultaneously. If the solution containing at least one metal salt of a metal selected from the group: ruthenium, rhodium, palladium, osmium, iridium and platinum is added to the silver salt solution before the solution containing hydroxide ions is added, or if the silver salt solution is initially mixed with the solution containing hydroxide ions and the solution containing at least one metal salt of a metal selected from the group: ruthenium, rhodium, palladium, osmium, iridium and platinum is only added to the solution subsequently, with the same sintering times this leads to a significantly lower conductivity than can be achieved with the metal nanoparticle sols for the production of which the three solutions are combined simultaneously.

Simultaneous combination of the three solutions in step a) may be carried out according to the invention by adding two of the three solutions to the third solution, in which case it is not important which of the solutions is selected. Simultaneous combination of the three solutions in step a) may also be carried out according to the invention by combining all three solutions, without treating one of the three solutions separately.

The present invention accordingly provides, in particular, metal nanoparticle sols which have been produced by the method according to the invention.

Without being restricted to a particular theory, it will be assumed that, in step a) of the method according to the invention, the metal cations present in the metal salt solution react with the hydroxide ions of the solution containing hydroxide ions and are thereby precipitated from the solution as metal oxides, metal hydroxides, mixed metal oxide-hydroxides and/or hydrates thereof. This process may be regarded as heterogeneous precipitation of nanoscale and submicroscale particles.

In the second step b) of the method according to the invention, the solution which contains the metal oxide/hydroxide particles is reacted with a reducing agent.

In the method according to the invention, the heterogeneous precipitation of the nanoscale and submicroscale particles in step a) is preferably carried out in the presence of at least one dispersant, also referred to as a protective colloid. As such dispersants, it is preferable to use those already mentioned above for the metal particle sols according to the invention.

In step a) of the method according to the invention, a molar ratio of from ≧0.5:1 to ≦10:1, preferably from ≧0.7:1 to ≦5:1, particularly preferably from ≧0.9:1 to ≦2:1 is preferably selected between the amount of hydroxide ions and the amount of metal cations.

The temperature at which method step a) is carried out may, for example, lie in a range of from ≧0° C. to ≦100° C., preferably from ≧5° C. to ≦50° C., particularly preferably from ≧10° C. to ≦30° C.

An equimolar ratio or an excess of the equivalents of the reducing agent of from ≧1:1 to ≦100:1, preferably from ≧2:1 to ≦25:1, particularly preferably from ≧4:1 to ≦5:1 in proportion to the metal cations to be reduced is preferably selected in the reduction step b).

The temperature at which method step b) is carried out may, for example, lie in a range of from ≧0° C. to ≦100° C., preferably from ≧30° C. to ≦95° C., particularly preferably from ≧55° C. to ≦90° C.

Acids or bases may be added to the solution obtained after step a) in order to set a desired pH. It is advantageous, for example, to keep the pH in the acidic range. In this way, it is possible to improve the monodispersity of the particle distribution in the subsequent step b).

The dispersant is preferably contained in at least one of the three solutions to be used (reactant solutions) for step a) in a concentration of from ≧0.1 g/l to ≦100 g/l, preferably from ≧1 g/l to ≦60 g/l, particularly preferably from ≧1 g/l to ≦40 g/l. If two or all three of the solutions to be used in step a) of the method according to the invention comprise the dispersant, then it is possible for the dispersants to differ and be present in different concentrations.

The selection of such a concentration range, on the one hand, ensures that the particles are covered with dispersant during precipitation from the solution to such an extent that the desired properties such as stability and redispersibility are preserved. On the other hand, excessive encapsulation of the particles with the dispersant is avoided. An unnecessary excess of dispersant could moreover react undesirably with the reducing agent. Furthermore, too large an amount of dispersant may be detrimental to the colloidal stability of the particles and make further processing more difficult. Not least, the selection makes it possible to process and obtain liquids with a viscosity which is readily handleable in terms of process technology.

The silver salt solution is preferably one containing silver cations and anions selected from the group: nitrate, perchlorate, fulminates, citrate, acetate, acetylacetonate, tetrafluoroborate or tetraphenylborate. Silver nitrate, silver acetate or silver citrate are particularly preferred. Silver nitrate is more particularly preferred.

The silver ions are preferably contained in the silver salt solution in a concentration of from ≧0.001 mol/l to ≦2 mol/l, particularly preferably from ≧0.01 mol/l to ≦1 mol/l, more particularly preferably from ≧0.1 mol/l to ≦0.5 mol/l. This concentration range is advantageous since, with lower concentrations, the solids content achieved for the nanosol may be too low and costly reprocessing steps might be necessary. Higher concentrations entail the risk that the precipitation of the oxide/hydroxide particles will take place too rapidly, which would lead to a nonuniform particle morphology. In addition, the particles would be aggregated further by the high concentration.

The solution containing at least one metal salt of a metal selected from the group: ruthenium, rhodium, palladium, osmium, iridium and platinum is preferably one containing a cation of a metal selected from the group: ruthenium, rhodium, palladium, osmium, iridium and platinum and at least one of the counteranions to the metal cations, selected from the group: nitrate, chloride, bromide, sulphate, carbonate, acetate, acetylacetonate, tetrafluoroborate, tetraphenylborate or alkoxide anions (alcoholate anions), for example ethoxide. The metal salt is particularly preferably at least one ruthenium salt, more particularly preferably one selected from ruthenium chloride, ruthenium acetate, ruthenium nitrate, ruthenium ethoxide or ruthenium acetylacetonate.

The metal ions are preferably contained in the metal salt solution in a concentration of from 0.01 g/l to 1 g/l.

The solution containing hydroxide ions can preferably be obtained by the reaction of bases selected from the group consisting of LiOH, NaOH, KOH, Mg(OH)₂, Ca(OH)₂, NH₄OH, aliphatic amines, aromatic amines, alkali metal amides, and/or alkoxides. NaOH and KOH are particularly preferred bases. Such bases have the advantage that they can be obtained economically and are easy to dispose of during subsequent effluent treatment of the solutions from the method according to the invention.

The concentration of the hydroxide ions in the solution containing hydroxide ions may advantageously and preferably lie in a range of from ≧0.001 mol/l to ≦2 mol/l, particularly preferably from ≧0.01 mol/l to ≦1 mol/l, more particularly preferably from ≧0.1 mol/l to ≦0.5 mol/l.

The reducing agent is preferably selected from the group consisting of polyalcohols, aminophenols, amino alcohols, aldehydes, sugars, tartaric acid, citric acid, ascorbic acid and salts thereof, thioureas, hydroxyacetone, iron ammonium citrate, triethanolamine, hydro-quinone, dithionites, such as, for example, sodium dithionite, hydroxymethanesulphinic acid, disulphites, such as, for example, sodium disulphite, formamidinesulphinic acid, sulphurous acid, hydrazine, hydroxylamine, ethylenediamine, tetramethylethylenediamine, hydroxylamine sulphate, borohydrides, such as, for example, sodium borohydride, formaldehyde, alcohols, such as, for example, ethanol, n-propanol, isopropanol, n-butanol, isobutanol, secbutanol, ethylene glycol, ethylene glycol diacetate, glycerol and/or dimethylaminoethanol. Formaldehyde is a particularly preferred reducing agent.

Further substances, such as low molecular weight additives, salts, foreign ions, surfactants and sequestrants, may also be added to the reactant solutions, a term which is also intended to include the solution of the reducing agent in step b), or the solution obtained after step a). The reactant solutions may furthermore be degassed before the reaction, for example in order to remove oxygen and CO₂. It is likewise possible for the reactant solutions to be handled under a protective gas and/or in the dark.

In order to remove accompanying substances and/or salts dissolved in the product dispersion, i.e. in the metal particle dispersion, and in order to concentrate the dispersion, it is possible to use the conventional methods of mechanical liquid separation (for example filtration through a pressure filter or in a centrifugal field, sedimentation in the gravitational field or a centrifugal field), extraction, membrane techniques (dialysis) and distillation.

The method according to the invention may be carried out as a batch method or as a continuous method. A combination of both method variants is also possible.

It is furthermore possible for the product dispersion to be concentrated by means of standard methods (ultrafiltration, centrifugation, sedimentation—optionally after adding flocculants or weak solvents—dialysis and evaporation) and optionally washed.

The colloidal chemical stability and the technical application properties of the product dispersion may possibly be optimized further by a washing step or by introducing additives.

In a particularly preferred embodiment of the present invention, at least one of the steps a) and b), and particularly preferably both of the steps a) and b), may be carried out in a microreactor. Here, in the scope of the present invention, “microreactor” refers to miniaturized, preferably continuously operating reactors which, inter alia, are known by the term “microreactor”, “minireactor”, “micromixer” or “minimixer”. Examples are T- and Y-mixers as well as the micromixers from a wide variety of companies (for example Ehrfeld Mikrotechnik BTS GmbH, Institut für Mikrotechnik Mainz GmbH, Siemens AG, CPC Cellular Process Chemistry Systems GmbH).

Microreactors are advantageous since the continuous production of micro- and nanoparticles by means of wet chemical and heterogeneous precipitation methods requires the use of mixing units. The aforementioned microreactors and dispersing nozzles or nozzle reactors may be used as mixing units. Examples of nozzle reactors are the MicroJetReactor (Synthesechemie GmbH) and the jet disperser (Bayer Technology Services GmbH). Compared with batch methods, continuously operating methods have the advantage that the scaling from the laboratory scale to the production scale can be simplified by the “numbering up” principle instead of the “scaling up” principle.

Another advantage of the method according to the invention is that, owing to the good controllability of product properties, conduct in a microreactor is possible without it becoming clogged during continuous operation.

It is preferable to carry out the heterogeneous precipitation method for producing the metal oxide/hydroxide particles as a micromethod in a capillary system comprising a first holding component, a second holding component, a microreactor, a third holding component and a pressure valve. In this case the reactant solutions, i.e. the silver salt solution, the metal salt solution and the solution containing hydroxide ions, are particularly preferably pumped with a constant flow rate through the apparatus, or the capillary system, by means of pumps or high-pressure pumps, for example HPLC pumps. Via the pressure valve after a cooler, the liquid is relaxed and collected in a product container through an exit capillary.

The microreactor is expediently a mixer having a mixing time of from ≧0.01 s to ≦10 s, preferably from ≧0.05 s to ≦5 s, particularly preferably from ≧0.1 s to ≦0.5 s.

Capillaries having a diameter of from ≧0.05 mm to ≦20 mm, preferably from ≧0.1 mm to ≦10 mm, particularly preferably from ≧0.5 mm to ≦5 mm are suitable as holding components.

The length of the holding components may expediently lie between ≧0.05 m and ≦10 m, preferably between ≧0.08 m and ≦5 m, particularly preferably between ≧0.1 m and ≦0.5 m.

The temperature of the reaction mixture in the system expediently lies between ≧0° C. and ≦100° C., preferably between ≧5° C. and ≦50° C., particularly preferably between ≧3° C. and ≦30° C.

The flow rates of the reactant flows per microreactor unit expediently lie between ≧0.05 ml/min and ≦5000 ml/min, preferably between ≧0.1 ml/min and ≦250 ml/min, particularly preferably between ≧1 ml/min and ≦100 ml/min.

Owing to the reduced sintering time for achieving comparable conductivities, compared with known silver particle sols, the metal particle sols according to the invention, and the metal particle sols produced by the method according to the invention, are suitable in particular for the production of conductive printing inks for the production of conductive coatings or conductive structures, as well as for the production of such conductive coatings or conductive structures.

The present invention therefore furthermore provides the use of the metal particle sols according to the invention for the production of conductive printing inks, preferably ones for inkjet and screenprinting methods, conductive coatings, preferably conductive transparent coatings, conductive microstructures and/or functional layers. The metal particle sols according to the invention are furthermore suitable for the production of catalysts, other coating materials, metallurgical products, electronic products, electroceramics, optical materials, biolabels, materials for forgery-secure marking, plastic composites, antimicrobial materials and/or active agent formulations.

The invention will be described in more detail below with the aid of examples, but without being restricted thereto.

### EXAMPLES

### Example 1 (According to the Invention)

a) Preparation of an Ag₂O/RuO₇ Nanoparticle Sol by a Batch Method

A 54 millimolar solution of silver nitrate (9.17 g/l AgNO₃) as reactant solution 1, a 54 millimolar solution of NaOH (2.14 g/l) with a dispersant concentration of 10 g/l as reactant solution 2 and a 0.12 molar RuCl₃ solution in ethanol as reactant solution 3 were prepared. Demineralized water (prepared with Milli-Qplus, QPAK® 2, Millipore Corporation) was used as the solvent. Disperbyk® 190 (Byk GmbH) was used as the dispersant. 250 ml of reactant solution 1 were placed in a glass beaker at room temperature. While stirring continuously, 250 ml of reactant solution 2 and 1 ml of reactant solution 3 were added uniformly to the reaction solution over a period of 10 s. The equivalent ratio of ruthenium to silver in the reactant mixture was therefore 9:1000 (0.9 wt % ruthenium, expressed in terms of the silver content). The batch was then restirred for a further 10 min. A grey-black coloured colloidally chemically stable Ag₂O/RuO₂ nanoparticle sol was obtained.

b) Reduction with Formaldehyde by a Batch Method

25 ml of a 2.33 molar aqueous formaldehyde solution (70 g/l) were added to 500 ml of the Ag₂O/RuO₂ nanoparticle sol prepared in Example la at room temperature while stirring continuously, stored for 30 min at 60° C. and cooled. A colloidally chemically stable sol comprising metallic, ruthenium oxide-doped silver nanoparticles was obtained. The particles were subsequently isolated by means of centrifugation (60 min at 30 000 rpm, Avanti J 30i, Rotor JA 30.50, Beckman Coulter GmbH) and redispersed in demineralized water by applying ultrasound (Branson Digital Sonifier). A colloidally chemically stable metal particle sol having a solids content of 10 wt % was obtained.

Analysis of the particle size by means of dynamic light scattering revealed crystalline nanoparticles having an effective hydrodynamic diameter of 128 nm. A ZetaPlus Zeta Potential Analyzer from Brookhaven Instrument Corporation was used for the measurement by means of dynamic light scattering.

A 2 mm wide line of this dispersion was applied onto a polycarbonate sheet (Bayer MaterialScience AG, Makrolon® DE1-1) and dried and sintered for ten minutes in an oven at 140° C. and ambient pressure (1013 hPa).

The conductivity was 3000 S/m after 10 min, and 4.4*10⁶ S/m after 60 min.

### Example 2 (According to the Invention)

a) Preparation of an Ag₂O/RuO₇ Nanoparticle Sol by a Batch Method

A 54 millimolar solution of silver nitrate (9.17 g/l AgNO₃) as reactant solution 1, a 54 millimolar solution of NaOH (2.14 g/l) with a dispersant concentration of 10 g/l as reactant solution 2 and a 0.12 molar RuCl₃ solution as reactant solution 3 were prepared. Demineralized water (prepared with Milli-Qplus, QPAK® 2, Millipore Corporation) was used as the solvent. Disperbyk® 190 was used as the dispersant. 250 ml of reactant solution 1 were placed in a glass beaker at room temperature. While stirring continuously, 250 ml of reactant solution 2 and 2.0 ml of reactant solution 3 were added uniformly to the reaction solution over a period of 10 s. The equivalent ratio of ruthenium to silver in the reactant mixture was therefore 18:1000 (1.8 wt % ruthenium, expressed in terms of the silver content). The batch was then restirred for a further 10 min. A grey-black coloured colloidally chemically stable Ag₂O/RuO₂ nanoparticle sol was obtained.

b) Reduction with Formaldehyde by a Batch Method

25 ml of a 2.33 molar aqueous formaldehyde solution (70 g/l) were added to 500 ml of the Ag₂O/RuO₂ nanoparticle sol prepared in Example 2a) at room temperature while stirring continuously, stored for 30 min at 60° C. and cooled. A colloidally chemically stable sol comprising metallic, ruthenium oxide-doped silver nanoparticles was obtained. The particles were subsequently isolated by means of centrifugation (60 min at 30 000 rpm, Avanti J 30i, Rotor JA 30.50, Beckman Coulter GmbH) and redispersed in demineralized water by applying ultrasound (Branson Digital Sonifier). A colloidally chemically stable metal particle sol having a solids content of 10 wt % was obtained.

A surface coating of this dispersion was applied onto a polycarbonate sheet in the same way as described in Example 1b). The conductivity determined similarly as in Example 1b) was 4.4*10⁶ S/m after 60 min.

### Comparative Example 3

### Ruthenium-Free Silver Nanosol

For comparison, a dispersion of sterically stabilized silver nanoparticles was prepared. To this end, a 0.054 molar silver nitrate solution was combined with a mixture of a 0.054 molar sodium hydroxide solution and the dispersant Disperbyk® 190 (1 g/l) in a volume ratio of 1:1 and stirred for 10 min. A 4.6 molar aqueous formaldehyde solution was added to this reaction mixture while stirring, so that the ratio of Ag⁺ to reducing agent is 1:10. This mixture was heated to 60° C., kept at this temperature for 30 min and subsequently cooled. The particles were separated from the unreacted reactants in a first step by means of diafiltration and the sol was subsequently concentrated. To this end, a 30 000 Dalton membrane was used. A colloidally stable sol having a solids content of up to 20 wt % (silver particles and dispersant) was obtained. According to elemental analysis after the membrane filtration, the proportion of Disperbyk® 190 was 6 wt %, expressed in terms of the silver content. A surface coating of this dispersion was applied onto a polycarbonate sheet in the same way as described in Example 1b). The specific conductivity determined similarly as in Example 1b) could only be determined after a drying and sintering time of one hour at 140° C. and ambient pressure (1013 hPa). The specific conductivity after drying and sintering time of one hour was about 1 S/m.

### Comparative Example 4

### Ruthenium-Doped Silver Nanosol Not According to the Invention

a) Preparation of an Ag₂O/RuO₇ Nanoparticle Sol by a Batch Method

A 54 millimolar solution of silver nitrate (9.17 g/l AgNO₃) as reactant solution 1, a 54 millimolar solution of NaOH (2.14 g/l) with a dispersant concentration of 10 g/l as reactant solution 2 and a 0.12 molar RuCl₃ solution as reactant solution 3 were prepared. Demineralized water (prepared with Milli-Qplus, QPAK® 2, Millipore Corporation) was used as the solvent. Disperbyk® 190 was used as the dispersant. 250 ml of reactant solution 1 were placed in a glass beaker at room temperature. While stirring continuously, 250 ml of reactant solution 2 and 0.1 ml of reactant solution 3 were added uniformly to the reaction solution over a period of 10 s. The equivalent mass ratio of ruthenium to silver in the reactant mixture was therefore 9:10 000 (0.09 wt % ruthenium, expressed in terms of the silver content). The batch was then restirred for a further 10 min. A grey-black coloured colloidally chemically stable Ag₂O/RuO₂ nanoparticle sol was obtained.

b) Reduction with Formaldehyde by a Batch Method

25 ml of a 2.33 molar aqueous formaldehyde solution (70 g/l) were added to 500 ml of the Ag₂O/RuO₂ nanoparticle sol prepared in Comparative Example 4a) at room temperature while stirring continuously, stored for 30 min at 60° C. and cooled. A colloidally chemically stable sol comprising metallic, ruthenium oxide-doped silver nanoparticles was obtained. The particles were subsequently isolated by means of centrifugation (60 min at 30 000 rpm, Avanti J 30i, Rotor JA 30.50, Beckman Coulter GmbH) and redispersed in demineralized water by applying ultrasound (Branson Digital Sonifier). A colloidally chemically stable metal particle sol having a solids content of 10 wt % was obtained.

A surface coating of this dispersion was applied onto a polycarbonate sheet in the same way as described in Example 1b). No specific conductivity could be detected similarly as in Example 3) even after drying and sintering time of one hour at 140° C. and ambient pressure (1013 hPa).

1. Metal nanoparticle sol having a metal particle content ≧1 g/l, containing
silver nanoparticles
at least one dispersant and
at least one liquid dispersion medium
characterized in that the metal nanoparticle sol contains from 0.1 to 10 wt % of at least one metal selected from the group consisting of: ruthenium, rhodium, palladium, osmium, iridium and platinum, expressed in terms of the silver content of the metal nanoparticle sol, in the form of the metal or at least one metal compound.

2. Metal nanoparticle sol according to claim 1, characterized in that the at least one metal is selected from the group consisting of: ruthenium, rhodium, palladium, osmium, iridium and platinum is ruthenium.

3. Metal nanoparticle sol according to claim 1, characterized in that at least 90 wt %, of the ruthenium is present in the form of ruthenium dioxide.

4. Metal nanoparticle sol according to claim 1, characterized in that the liquid dispersion medium is water or a mixture containing at least 50 wt %.

5. Metal nanoparticle sol according to claim 1, characterized in that the dispersant is a polymeric dispersant, preferably one with a weight average M_{w}, from 100 g/mol to 1 000 000 g/mol.

6. Metal nanoparticle sol according to claim 1, characterized in that the dispersant is at least one dispersant selected from the group consisting of alkoxylates, alkylolamides, esters, amine oxides, alkyl polyglucosides, alkylphenols, arylalkylphenols, water-soluble homopolymers, statistical copolymers, block copolymers, graft polymers, polyethylene oxides, polyvinyl alcohols, copolymers of polyvinyl alcohols and polyvinyl acetates, polyvinylpyrrolidones, cellulose, starch, gelatin, gelatin derivatives, amino acid polymers, polylysine, polyasparagic acid, polyacrylates, polyethylene sulphonates, polystyrene sulphonates, polymethacrylates, condensation products of aromatic sulphonic acids with formaldehyde, naphthalene sulphonates, lignosulphonates, copolymers of acrylic monomers, polyethyleneimines, polyvinylamines, polyallylamines, poly(2-vinylpyridines) polydiallyldimethylammonium chloride and mixtures thereof.

7. Metal nanoparticle sol according to claim 1, characterized in that the metal nanoparticle sol contains from 0.1 to 5 wt %, of at least one metal selected is selected from the group consisting of: ruthenium, rhodium, palladium, osmium, iridium and platinum, expressed in terms of the silver content, in the form of the metal or at least one metal compound.

8. Method for producing a metal nanoparticle sol according to claim 1, characterized in that
a) a silver salt solution, a solution containing at least one metal salt of a metal selected from the group consisting of: ruthenium, rhodium, palladium, osmium, iridium and platinum, and a solution containing hydroxide ions are combined,
b) the solution obtained from step a) is subsequently reacted with a reducing agent,
at least one of the solutions in step a) containing at least one dispersant, characterized in that the three solutions are combined simultaneously in step a).

9. Method according to claim 8, characterized in that the silver salt solution is one containing silver cations and anions selected from the group consisting of: nitrate, perchlorate, fulminates, citrate, acetate, acetylacetonate, tetrafluoroborate or tetraphenylborate.

10. Method according to claim 8, characterized in that the solution containing hydroxide ions can be obtained by the reaction of bases selected from the group consisting of LiOH, NaOH, KOH, Mg(OH)₂, Ca(OH)₂, NH₄OH, aliphatic amines, aromatic amines, alkali metal amides, alkoxides and mixtures thereof.

11. Method according to claim 8, characterized in that the reducing agent is selected from the group consisting of polyalcohols, aminophenols, amino alcohols, aldehydes, sugars, tartaric acid, citric acid, ascorbic acid and salts thereof, triethanolamine, hydroquinone, sodium dithionite, hydroxymethanesulphinic acid, sodium disulphite, formamidinesulphinic acid, sulphurous acid, hydrazine, hydroxylamine, ethylenediamine, tetramethylethylenediamine, hydroxylamine sulphate, sodium borohydride, formaldehyde, alcohols, ethanol, n-propanol, isopropanol, n-butanol, isobutanol, sec-butanol, ethylene glycol, ethylene glycol diacetate, glycerol dimethylaminoethanol and mixtures thereof.

12. Method according to claim 8, characterized in that the metal salt of a metal selected from the group consisting of: ruthenium, rhodium, palladium, osmium, iridium and platinum is at least one ruthenium salt selected from ruthenium chloride, ruthenium acetate, ruthenium nitrate, ruthenium ethoxide, ruthenium acetylacetonate.

13. (canceled)

14. (canceled)

15. A conductive prinking ink comprising a metal nanoparticle sol according to claim 1

16. A conductive coating composition comprising metal nanoparticle sol according to claim 1.

17. A conductive structure coated with a conductive coating composition according to claim 16.

18. Metal nanoparticle sol according to claim 2, characterized in that at least 90 wt % of the ruthenium is present in the form of ruthenium dioxide.

19. Metal nanoparticle sol according to claim 18, characterized in that the liquid dispersion medium is water or a mixture containing at least 50 wt % of water.

20. Metal nanoparticle sol according to claim 19, characterized in that the dispersant is a polymeric dispersant, preferably one with a weight average M_{w}, from 100 g/mol to 1 000 000 g/mol.
